(19) United States
(12) Patent Application Publication
(10) Pub. No.: US 2005/0239416 A1
(43) Pub. Date: Oct. 27, 2005

(54) Portable radio apparatus

(75) Inventor: Takayuki Shimizu, Higashiyamato (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/890,074

(22) Filed: Jul. 12, 2004

(30) Foreign Application Priority Data
Apr. 1, 2004 (JP) 2004-109051

(51) Int. Cl. H04B 7/00

(52) U.S. Cl. 455/82; 455/277.1

(57) ABSTRACT

A portable radio apparatus of high reliability. A cellular phone consists of a plurality of radio antennas each of which receives radio waves and outputs a radio signal according to the intensity of the received radio waves, a modem that combines received two or more signals to producing a synthetic radio-wave signal; and two or more reception units that receive two or more radio signals outputted by the plurality of radio antennas and input to the modem two or more signals based on the outputted plurality of radio signals.

### INCORPORATION BY REFERENCE

The present application claims priority from Japanese application JP2004-109051 filed on Apr. 1, 2004, the content of which is hereby incorporated by reference into this application.

### BACKGROUND OF THE INVENTION

The present invention relates to portable radio apparatus.

Usually, a portable radio apparatus cannot perform wireless communication such as a telephone call when it cannot receive radio waves of more than a predetermined intensity. The radio waves emitted from a base station are reflected or diffracted by environmental terrain/buildings and reach the portable radio apparatus via various routes. In this case, multipath fading occurs in which the intensity of received radio waves is reduced and its quantity of reduction varies depending on the shape of a space through which the radio waves are transmitted, the frequency of the radio waves or time. In order to alleviate the influence of such multipath fading, antenna diversity methods are known.

For example, patent reference 1 (JP-A-11-186945) discloses a portable radio information terminal with a whip antenna and an inverted-F antenna. In reference 1, one of the whip and inverted-F antennas is selected as a reception antenna when the terminal cover is opened/closed (for example, FIGS. 1 and 3).

Another patent reference 2 (JP-A-2002-261665) discloses a portable radio apparatus with three transmission/reception antennas provided respectively at ends of its upper and lower housings and in the vicinity of a hinge that rotatably couples the upper and lower housings. In an antenna diversity process to be performed when the radio apparatus is placed in a reception state, the radio apparatus senses a transmission/reception antenna of the highest reception level from among the three antennas and uses this antenna as a transmission antenna when the signal is transmitted.

Data is often downloaded from a desired Web site using such radio apparatus. In this case, a large amount of data may be received or data may be received over a long time. In such a case, if the radio-wave reception sensitivity is reduced depending on reductions in the receiving field strength, the apparatus may fail in reception of the data.

Therefore, it is an object of the present invention to provide a portable radio apparatus of high reliability. Another object of the present invention will be clarified from the following descriptions.

### SUMMARY OF THE INVENTION

A portable radio apparatus according to one aspect of the present invention, comprises: a plurality of radio antennas each of which receives radio waves and outputs a radio-wave signal according to the intensity of the received radio waves; a signal synthesis unit that receives and combines two or more signals to produce a synthetic radio-wave signal; and two or more reception units that input to the signal synthesis unit two or more signals based on the received plurality of radio signals that are outputted from the plurality of radio antennas.

Here, the “two or more signals based on the received plurality of radio signals” may be, for example, either the received plurality of radio signals themselves or signals obtained by processing the received plurality of radio-wave signals in some manner or other. More specifically, one of the two or more signals may be obtained by adding two or more of the received plurality of radio-wave signals.

In a first embodiment, the plurality of radio antennas may comprise one or more main transmission/reception antennas and two or more reception subantennas. The main transmission/reception antenna is used for both transmission and reception of radio-wave signals. The reception subantennas are used only for reception of signals, not used for signal transmission. For reception of signals, the portable radio apparatus uses the main transmission/reception antenna and one or more reception subantennas selected from the two or more reception subantennas. More particularly, a first one of the two or more reception units receives a radio-wave signal outputted from the main transmission/reception antenna and inputs to the signal synthesis unit a signal which is based on the received radio-wave signal (for example, the signal obtained by demodulating the received radio-wave signal). One or more second ones of the two or more reception units receive one or more radio-wave signals outputted respectively from one or more reception subantennas selected from the two or more reception subantennas and input to the signal synthesis unit one or more signals that are based on (or obtained by demodulating) the received one or more radio-wave signals.

In a second embodiment, the portable radio apparatus of the first embodiment may comprise: a first (for example, lower) housing; a second (for example, upper) housing connected openably to the first housing; an opening/closing sensor (hereinafter referred to as opening sensor) that senses an open/close state of the second housing relative to the first housing; and an antenna selector that selects a desired one or more reception subantennas to be used from the two or more reception subantennas based on a result of sensing by the opening/closing sensor.

In a third embodiment, each of the first and second housing of the second embodiment has opposite ends, one of which is hereinafter referred to as a “base end” and the other as a “tip end”. When the second housing is closed relative to the first housing, the base end of the second housing is located on the base end side of the first housing and the tip end of the second housing is located on the tip end side of the first housing. When the second housing is open relative to the first housing, the base end of the second housing is located on the base end side of the first housing, whereas the tip end of the second housing is remotest from the tip end of the first housing. The main transmission/reception antenna is provided at the tip end side of the first housing. The first reception subantenna is provided at the base end side of the first or second housing. The second reception subantenna is provided at the tip end side of the second housing. The antenna selector selects the first reception subantenna when the opening sensor senses that the second housing is closed against the first housing whereas the antenna selector selects the second reception subantenna when the opening sensor senses that the second housing is open relative to the first housing. The second reception unit receives a radio-wave signal outputted from the reception subantenna selected by the antenna selector. In this third embodiment, the apparatus is opened/closed in a folding manner.

In a fourth embodiment, when the second housing is closed against the first housing in the second embodiment, the base end of the second housing is located on the base end side of the first housing and the tip end of the second housing is located on the tip end side of the first housing. When the second housing is open relative to the first housing, the base end of the second housing is remotest from the tip end of the first housing and the tip end of the second housing is located on the base end side of the first housing. The main transmission/reception antenna is provided at the tip end side of the first housing. The second reception subantenna is provided at the base end side of the second housing. The first reception subantenna is provided at the base end side of the first or second housing. The antenna selector selects the first reception subantenna when the opening/closing sensor senses that the second housing is closed against the first housing whereas the antenna selector selects the second reception subantenna when the opening sensor senses that the second housing is open relative to the first housing. The second reception unit receives a radio-wave signal from the reception subantenna selected by the antenna selector. In this fourth embodiment, the apparatus is opened/closed in a sliding manner.

In a fifth embodiment, the plurality of radio antennas comprise one or more main transmission/reception antennas and two or more reception subantennas. The main transmission/reception antenna is used for both transmission and reception of radio waves. The reception subantennas are used only for reception of radio waves, not used for signal transmission. One or more of the two or more reception subantennas are directed so as to be different in polarization plane from the one or more main transmission/reception antennas. In that case, for example, a first one of the plurality of reception units receives a radio-wave signal outputted from the main transmission/reception antenna and inputs a signal based on the received radio-wave signal to the signal synthesis unit. One or more of the second ones of the two or more reception units receive one or more signals which are based on two or more radio-wave signals respectively outputted from the two or more reception subantennas and input signals which are based on the received one or more signals to the signal synthesis unit.

In a sixth embodiment, the portable radio apparatus of the fifth embodiment further comprises: a coupler that adds two or more radio-wave signals respectively outputted from the two or more reception subantennas to obtain an addition signal and inputs the addition signal to any one (for example, the second reception unit) of the twob or more reception units.

In a seventh embodiment, the portable radio apparatus of the sixth embodiment further comprises: a phase adjuster that adjusts phases of the two or more received radio-wave signals outputted from the two or more reception subantennas so as to be in-phase with each other. The coupler receives the two or more radio-wave signals whose phases are adjusted by the phase adjuster.

According to the present invention, portable radio apparatus of high reliability are provided.

Other objects, features and advantages of the invention will become apparent from the following description of the embodiments of the invention taken in conjunction with the accompanying drawings.

### BRIEF DESCRIPTION OF THE DRAWINGS

FIGS. 1A and 1B schematically illustrate appearance of a cellular (mobile) phone of a first embodiment of the present invention;

FIG. 2 is a block diagram showing the constitution of the cellular phone of FIG. 1;

FIGS. 3A and 3B schematically illustrate appearance of a cellular phone according to a second embodiment of the present invention;

FIGS. 4A and 4B schematically illustrate appearance of a cellular phone according to a modification of the second embodiment of the present invention; and

FIG. 5 is a block diagram showing the constitution of the cellular phone of FIG. 4. according to a third embodiment.

### DESCRIPTION OF THE EMBODIMENTS

A portable radio apparatus according to the present invention can be applied to various types of portable radio apparatuses that are capable of being opened/closed including cellular phones, PHSs (Personal Handy phone Systems), PDAs (Personal Digital Assistants), and note type personal computers. Now, an embodiment of the present invention will be described taking a cellular phone as one example of the portable radio apparatus.

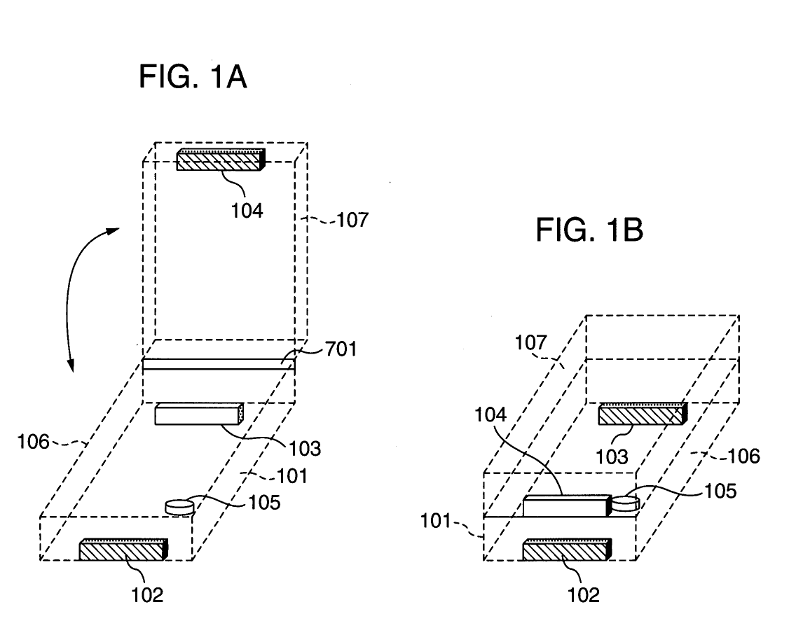

FIGS. 1A and 1B schematically illustrate appearance of a cellular phone according to a first embodiment of the present invention. A cellular phone 101 is of the so-called folding type having an upper and a lower housing 107 and 106 coupled openable at base ends thereof by a hinge 701. Thus, the upper housing 107 is capable of being opened and closed relative to the lower housing 106. In other words, the portable phone 101 can be opened and closed about a center axis, namely, about the hinge 701. FIG. 1A illustrates the cellular phone 101 in in-the-midst-of-opening/closing state (hereinafter referred to as “opening/closing state”) and FIG. 1B illustrates the cellular phone 101 in a closed state. The “closed state” refers to a completely closed state which in turn is a starting state of the opening operation, whereas an “open state” refers to the state in which the cellular phone has been completely opened which in turn is a starting state of the closing operation. The opening/closing state refers to an intermediate state between the “closed state” and the “open state”. An “open/close” state collectively refers to any of those states.

The cellular phone 101 has an opening sensor 105 that senses whether the cellular phone 101 is in the closed state or not (or whether it is in the opened state or not). The opening sensor 105 may be any one of various sensors. For example, it may be a mechanical switch or a switch constituted by a combination of a magnet and a Hall element or an optical sensor.

The cellular phone 101 has a plurality of radio antennas such as, for example, one or more main transmission/reception antennas 102 and two or more reception subantennas 103 and 104.

Each main transmission/reception antenna 102 is a radio antenna that is used to both transmit signals and receive radio waves. The main antenna 102 is used irrespective of a result of sensing by the opening sensor 105, or whether or not the cellular phone 101 is in the closed state or in the opened state. When the main antenna 102 receives radio waves, it outputs a radio-wave signal according to the intensity of the received radio waves, namely, for example, a radio-wave signal having a signal level according to the intensity of the received radio waves.

On the other hand, one of the first and second reception subantennas 103 and 104 is selectively used in accordance with a result of sensing by the opening sensor 105. The reception subantennas 103 and 104 are used only for receiving radio waves, not used for signal transmission. The reception subantennas 103 and 104 output a radio-wave signal according to the intensity of the received radio waves, namely, for example, a radio-wave signal having a signal level according to the intensity of the received radio waves.

Each of the plurality of radio-wave antennas may be provided within the cellular phone or on an outside thereof (for example, the antennas may be extensible whip antennas). Any number of such radio wave antennas may be employed at any positions inside or outside the cellular phone 101. Preferably, they may be disposed as follows.

For example, when the cellular phone 101 is in the closed state, the main antenna 102 and the first subantenna 103 are disposed preferably in such a positional relation that the distance therebetween (hereinafter referred to as “main-1^{st} antenna distance”) becomes the longest possible. For example, the main antenna 102 may be provided at the tip end side of the lower housing 106 (for example, on or near the tip end) whereas the first reception subantenna 103 may be provided at the base end side of the lower housing 106 (for example, on or near the base end thereof).

Preferably, the main transmission/reception antennas 102 and the second reception subantenna 104 are disposed in such a positional relation that when the cellular phone 101 is in the opened state, the distance between the main antenna 102 and the second subantenna 104 (hereinafter referred to as “main-2^{nd} antenna distance”) may become the longest possible. For example, as described above, the main antenna 102 is provided at the tip end side of the lower housing 106 (for example, on or near the tip end thereof) whereas the second subantenna 104 may be provided at the tip end side of the upper housing 107 (for example, on or near the tip end thereof).

As long as the antenna 102, and the first and second subantennas 103 and 104 satisfy the above-mentioned positional relationship, they may be disposed at any positions. For example, the positions of the main antenna 102 and the second subantenna 104 may be reversed. Any one of the first and second reception subantennas 103 and 104 may be disposed so as to be authogonal in direction to the main antenna 102.

Now, referring to FIGS. 1A and 1B, operation of the cellular phone 101 to be performed to select a radio antenna to be used will be described.

As shown in FIG. 1A, when the opening sensor 105 senses that the cellular phone 101 is opened by a certain degree (for example, that the main-2^{nd} antenna distance is longer than the main-1^{st} antenna distance) or, in other words, when for example the opening sensor detects that the cellular phone 101 is not in the closed state, the second subantenna 104 is selected from among the first and second reception subantennas 103 and 104 and is used along with the main antenna 102 for receiving radio waves. Note that in FIG. 1A the radio antenna 102 and the second subantenna 104 used are shown to be hatched.

As shown in FIG. 1B, when the cellular phone 101 is in the closed state to some degree (for example, when the main-1^{st} antenna distance is longer than the main-2^{nd} antenna distance), or more specifically, when for example the opening sensor 105 senses that the cellular phone 101 is in the closed state to some extent, the first subantenna 103 is selected from among the first and second reception subantennas 103 and 104 and is used along with the main antenna 102 for receiving radio waves (FIB. 1B shows hatched the radio antennas 102 and 103 to be used).

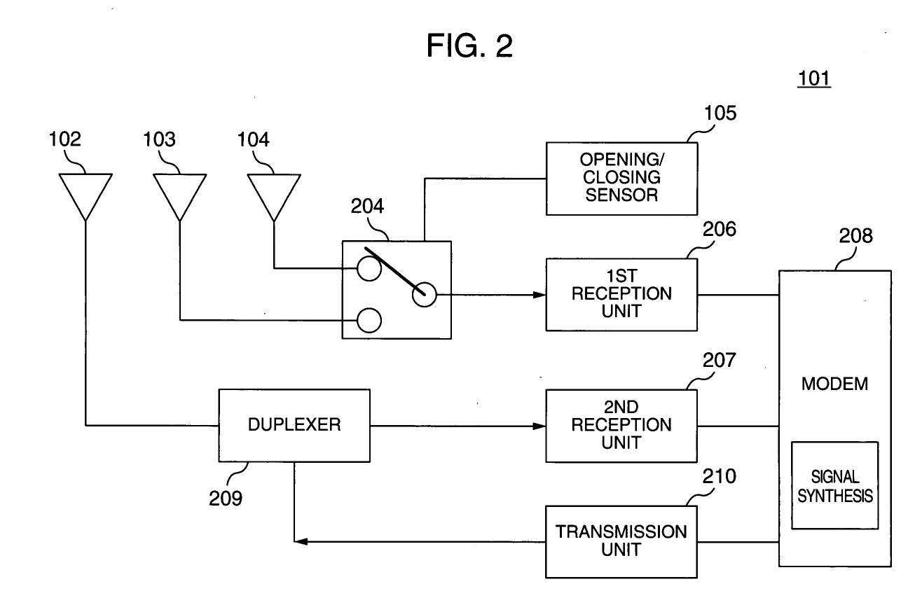

FIG. 2 is a block diagram showing the constitution of the cellular phone 101.

The cellular phone 101 consists of an antenna switch 204, a first reception unit 206, a second reception unit 207, a transmission unit 210, a modem 208 and a duplexer 209.

The antenna switch 204 selects one of the first and second subantennas 103 and 104 as an antenna to be connected to the first reception unit 206 based on a signal received from the opening sensor 105 (in other words, a result of sensing by the opening sensor 105).

The first and second reception units 206 and 207 are circuitry for subjecting the received signals to demodulation processing (for example, amplifying processing). More specifically, the first reception unit 206 receives and demodulates a radio wave signal outputted from the first or second subantenna 103 or 104 selected by the antenna switch 204, and then outputs a resulting signal to the modem 208. The second reception unit 207 receives via the duplexer 209 and demodulates a radio wave signal outputted from the main antenna 102, and then outputs it to the modem 208. The radio wave signals inputted to the reception units 206 and 207 may be the ones processed after being outputted from the antennas.

The transmission unit 210 outputs a signal received from the modem 208 via the duplexer 209 to the main antenna 102.

The modem 208 subjects a first demodulated signal received from the first reception unit 206 and a second demodulated signal received from the second reception unit 207 to signal synthesis processing to output a resulting combined or synthesized radio wave signal. The modem 208 demodulates a signal received from a circuit (not shown) of the cellular phone 101, and then outputs a resulting signal to the transmission unit 210.

When the duplexer 209 receives a transmit signal from the transmission unit 210, it connects the main antenna 102 to the transmission unit 210 and then outputs the received transmit signal to the main antenna 102. Otherwise, namely, if the duplexer 209 receives no signals from the transmission unit 210, it connects the main antenna 102 to the second reception unit 207 and then inputs a radio wave signal received from the main antenna 102 to the second reception unit 207.

As will be seen from FIG. 2 and the above descriptions, the cellular phone 101 has a plurality of reception antennas and a plurality of reception systems. In this embodiment, two radio antennas, namely, the main antenna 102 and a selected one of the subantennas 103 and 104, are necessarily used as reception antennas in the reception of radio waves. Further, in this embodiment are used two receiving systems, namely, the second reception unit 207 that receives a radio wave signal from the main antenna 102, and the first reception unit 206 that receives a radio wave signal from the selected subantenna 103 or 104.

In receiving the radio waves, the first reception unit 206 receives the radio wave signal from the antenna 103 or 104, and the second reception unit 206 receives the radio signal from the antenna 102. Then, the modem 208 combines the two received radio wave signals (correctly speaking, two demodulated received radio-wave signals) and then outputs a resulting signal.

At this time, the antenna switch 204 selects one of the first and second subantennas 103 and 104 as a reception subantenna to be used actually, based on a result of the sensing by the opening sensor 105. More specifically, when the cellular phone 101 is in the open state to some degree, the opening sensor 105 delivers to the antenna switch 204 a sensed result signal indicating that the cellular phone 101 is not in the closed state. The antenna switch 204 responds to the sensed result signal to thereby select the second reception subantenna 104 as one to be connected to the first reception unit 206 instead of the first reception subantenna 103. On the other hand, when the cellular phone 101 is in the closed state, the opening sensor 105 senses this state and delivers to the antenna switch 204 a sensed result signal indicating that state. The antenna switch 204 responds to the sensed result signal to thereby select the first reception subantenna 103 as one to be connected to the first reception unit 206 instead of the second subantenna 104.

According to the first embodiment, a cellular phone of a high reception sensitivity can be provided. Further, according to the first embodiment, a cellular phone having a stable reception sensitivity is provided irrespective of changes in the reception field intensity.

In the first embodiment, two or more radio antennas selected from a plurality of radio antennas receive radio waves so that two or more received radio wave signals respectively outputted from the two or more radio antennas may be used. With the arrangement, the reception sensitivity of the cellular phone 101 can be improved. In this respect, it was proved by the inventor's tests that when a single received radio-wave signal was used while the cellular phone 101 was being moved at a speed of approximately 60 km/hour, the C/I (Carrier to Interference power ratio) was approximately 2.0 dB on average, the downward data communication rate was approximately 340 kbps on average whereas two received radio-wave signals were used, the C/I was approximately 5.5 dB on average and the downward communication rate was approximately 600 kbps on average. These data exhibit remarkable improvement in CI and downward communication rate.

According to the first embodiment, the main transmission/reception antenna 102 and the plurality of reception subantennas 103 and 104 are provided. The main transmission/reception antenna 102 is always used for receiving purposes. When the cellular phone 101 is in the open state to a certain extent or more, the second reception subantenna 104 is selected from among the plurality of the reception subantennas 103 and 104 which provides a longer inter-antenna distance from the main transmission/reception antenna 102 whereas when the cellular phone 101 is in the closed state to less than a certain extent, the first reception subantenna 103 is selected which provides a longer inter-antenna distance from the main antenna 102. Thus, one of the plurality of reception subantennas 103 and 104 that is considered to have a higher radio-wave reception intensity is used for receiving purposes from a standpoint of space diversity. With the arrangement, the reception sensitivity of the cellular phone 101 is improved. In other words, radio waves having a higher reception intensity can be received to thereby improve the diversity reception effect.

According to the first embodiment, which of the reception subantennas 103 and 104 is to be used is determined based only on a result of sensing by the opening sensor 105. Thus, a reception subantenna having a higher radio-wave reception intensity can be selected with a small burden for the cellular phone 101.

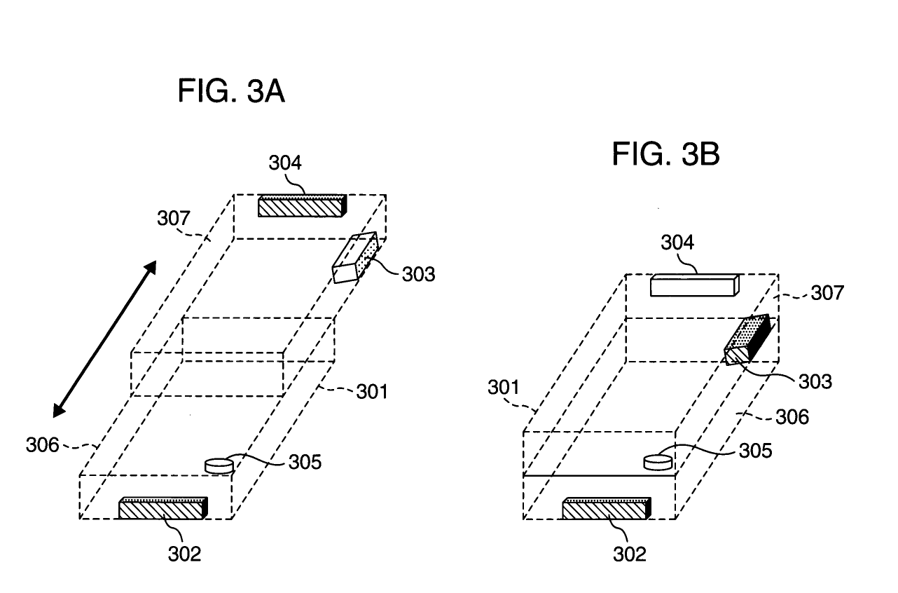

FIGS. 3A and 3B schematically illustrate appearance of a cellular phone according to a second embodiment of the invention. Where the second embodiment is different from the first embodiment will be mainly described and further description of the second embodiment will be omitted or described briefly.

The cellular phone 301 of the second embodiment has a slide structure in which when an upper housing 307 is slid fully in a first (for example, in the direction of the base end of the upper housing 307) relative to the lower housing 306, the cellular phone 301 is placed in the open state. Conversely, when the upper housing 307 is fully slid relative to the lower housing 306 in a second direction (for example, in the direction of the tip end of the upper housing 307), the cellular phone 301 is placed in the closed state, as shown in FIG. 3B. Note that FIG. 3A illustrates the cellular phone 301 in the opening/closing state, namely, the intermediate state between the closed state and open state.

In the second embodiment, the main transmission/reception antenna 302 is disposed at the tip end side of the lower housing 306 (for example, on or near the tip end). The second reception subantenna 304 is disposed at the base end side of the upper housing 307 (for example, at or near the base end). Thus, when the cellular phone 301 is in the open state, the antenna distance between the main antenna 302 and the second subantenna 304 becomes the longest possible.

The first reception subantenna 303 is disposed at or near a side of the upper housing 307 in the direction traversing the direction of the second reception subantenna 304 (for example, in the direction generally orthogonal to the subantenna 304 direction). This arrangement is to make the polarization planes of the first and second reception subantennas different from each other, in order to obtain a polarization diversity effect that utilizes different polarization planes that receive radio waves from a base station (not shown). As long as the first reception subantenna 303 faces sideways, it may be disposed anywhere on the upper housing 307. Preferably, it is disposed at such a position that the distance from the main antenna 302 becomes as large as possible (for example, near a side of the upper housing 307 at the base end side thereof) when the cellular phone 301 is in the closed state (FIG. 3B) in order to obtain a space diversity effect in addition to the polarization diversity effect.

The cellular phone 301 may be similar in internal construction to the cellular phone 101. Operation of the cellular phone 301 when a radio antenna used is being switched will be described referring to FIGS. 3A and 3B.

As shown in FIG. 3A, when the opening sensor 305 senses that the cellular phone 301 is in the open state to some degree (for example, the main-2^{nd} antenna distance in the opening process becomes longer than the main-1^{st} antenna distance in the closed state) or, in other words, when the opening sensor 305 detects that the cellular phone 301 is not in the closed state, the second subantenna 304 is selected instead of the first reception subantenna 303 and is used along with the main antennas 302 for receiving radio waves. FIG. 3A shows hatched the antennas 302 and 304 to be used.

As shown in FIG. 3B, when the opening sensor 305 senses that the cellular phone 301 is in the closed state to some degree (for example, when the main-1^{st} antenna distance is longer than the main-2^{nd} antenna distance) or, more specifically, when the opening sensor detects that the cellular phone 301 is in the closed state, the first subantenna 303 is selected instead of the second reception subantenna 304 and is used along with the main antenna 302 to receive radio waves. FIG. 3B is shown hatched the antennas 302 and 303 to be used). As described above, in the closed state the length of the cellular phone 301 and hence the anntena-subantenna distance are reduced compared to that in the open state, thereby reducing the space diversity effect. However, by selecting the first reception subantenna 303, whose surface that receives radio waves is different in direction from that of the main antenna 102, as a radio antenna for radio wave reception, it is ensured by virtue of the polarization diversity that the inter-antenna distance substantially equal to at least the length of the cellular phone 301 in the closed state is retained while compensating for a decrease in the inter-antenna distance from that shown in FIG. 3A.

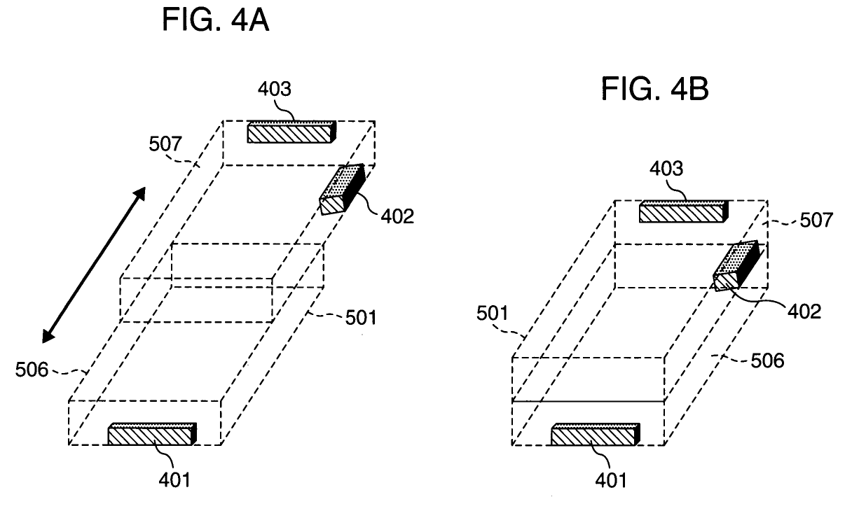

FIGS. 4A and 4B schematically illustrate appearance of a cellular phone as a modification of the second embodiment. Where the modification is different from the second embodiment will be mainly described and further description thereof will be omitted.

The cellular phone 501 in this modification consists of a main transmission/reception antenna 401, a first reception subantenna 402 and a second reception subantenna 403 as in the cellular phone 301 of the second embodiment. In the cellular phone 501, the first and second reception subantennas 402 and 403 are used along with the transmission/reception main antenna 401 in signal reception whether the cellular phone 501 is in the open state or in the closed state, as shown hatched.

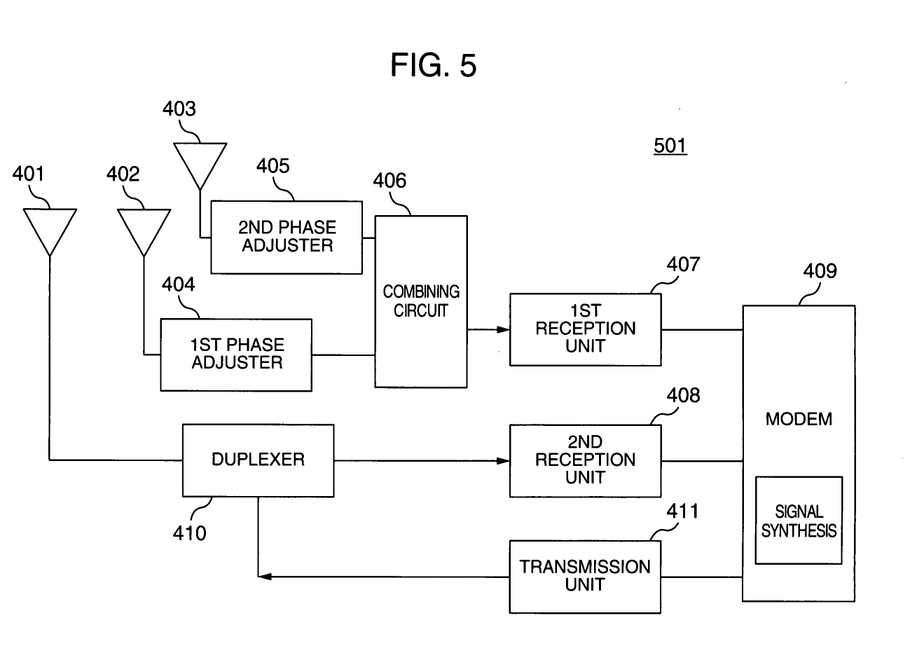

FIG. 5 is a block diagram of the cellular phone 501. The cellular phone 501 also consists of a first phase matching circuit 404 that receives a received radio-wave signal from the first reception subantenna 402, a second phase matching circuit 405 that receives a received radio-wave signal from the second reception subantenna 403 and a coupling circuit 406.

The phase matching circuits 404 and 405 adjust the phases of the signals from the first and second reception subantennas 402 and 403 so as to be equal or in-phase with each other. For sensing and adjusting a phase deviation, a method based on an equal gain synthesis method or an in-phase synthesis method, for example, may be employed. When a phase deviation between the two signals is small, the two phase matching circuits 404 and 405 may be eliminated. In this case, the cellular phone 501 is reduced in size.

The coupling circuit 406 adds the signals received from the first and second phase matching circuits 404 and 405, and outputs a resulting addition signal as a first diversity branch to the first reception unit 407.

The remaining structure of the cellular phone 501 is similar to those of the first and second embodiments. That is, the second reception unit 408 receives as a second diversity branch a radio signal from the main antenna 401 via the duplexer 410, and outputs it to the modem 409. The modem 409 then combines the signals from the first and second reception units 407 and 408 and outputs a resulting signal.

According to this modification, the signals received from all the antennas disposed are used, thereby improving the reception sensitivity of the cellular phone 501 and in other words improving its diversity reception effect. The number of reception subantennas may be three or more.

While some embodiments of the invention have been described, these are only for illustrating purposes and not intended to limits the scope of the present invention to these embodiments. The present invention may be implemented in various other forms. For example, the cellular phones may be opened/closed in other manners and not limited to the folding/sliding systems disclosed. In the first and/or second embodiment, the opening sensor 105 may be an intelligence one that senses an open degree of the cellular phone such that which of the main-1^{st} antenna distance and the mkain-2^{nd} antenna distance is greater is determined based on the sensed open degree of the cellular phone, and a result of the determination is inputted to the antenna switch 204 to thereby cause the antenna switch 204 to select one of the reception subantennas 103 and 104 for the greater distance. In addition, in the first and second embodiments and the modification the plurality of radio antennas may be provided on the upper housing and other components of the cellular phone may be provided on or within the lower housing.

It should be further understood by those skilled in the art that although the foregoing description has been made on embodiments of the invention, the invention is not limited thereto and various changes and modifications may be made without departing from the spirit of the invention and the scope of the appended claims.

1. A portable radio apparatus comprising:
a plurality of radio antennas each of which receives radio waves and outputs a radio signal according to the intensity of the received radio waves;
a signal synthesis unit that receives and combines a plurality of signals, thereby producing a synthetic radio-wave signal; and
two or more reception units that receive a plurality of radio wave signals respectively from said plurality of radio antennas and input to said signal synthesis unit two or more signals based on said received plurality of radio wave signals.

2. The portable radio apparatus of claim 1, wherein:
said plurality of radio antennas include a main transmission/reception antenna and two or more reception subantennas;
said main transmission/reception antenna is used for both signal transmission and radio wave reception;
said reception subantennas are used only for radio wave reception, not used for signal transmission; and
wherein said main transmission/reception antenna and one or more reception antennas selected from said two or more reception subantennas are used for signal reception.

3. The portable radio apparatus of claim 2, further comprising:
a first housing;
a second housing connected openably to the first housing;
an opening/closing sensor that senses an open/close state of the second housing relative to the first housing; and
an antenna selector that selects one or more reception subantennas to be used from said two or more reception subantennas based on a sensing result of said opening/closing sensor.

4. The portable radio apparatus of claim 3, wherein
when said second housing is in a closed state relative to said first housing, a base end of said second housing is located on a base end side of said first housing and a tip end of said second housing is located on a tip end side of said first housing;
when said second housing is in an open state relative to said first housing, said base end of said second housing is located on the base end side of said first housing and said tip end of said second housing is located remotest from said tip end of said first housing;
said main transmission/reception antenna is provided at tip end side of said first housing;
said first reception subantenna is provided at the base end side of said first or second housing;
said second reception subantenna is provided at the tip end side of said second housing;
said antenna selector selects said first reception subantenna when said opening/closing sensor senses that said second housing is in the closed state relative to said first housing whereas said antenna selector selects said second reception subantenna when said opening/closing sensor senses that said second housing is in the open state relative to the first housing;
said second reception unit receives a radio-wave signal outputted from the reception subantenna selected by said antenna selector.

5. The portable radio apparatus of claim 3, wherein
when said second housing is closed relative to said first housing, a base end of said second housing is located on a base end side of said first housing and a tip end of said second housing is located on a base end side of said first housing;
when said second housing is in an open state relative to said first housing, the base end of said second housing is located remotest from the tip end of said first housing and the tip end of said second housing is located on the base end side of said first housing;
said main transmission/reception antenna is provided at the tip end side of the first housing;
said second reception subantenna is provided at the base end side of said second housing;
said first reception subantenna is provided at the base end side of said first or second housing;
said antenna selector selects said first reception subantenna when said opening/closing sensor senses that said first housing is in the closed state relative to said second housing whereas said antenna selector selects said second reception subantenna when said opening/closing sensor senses that said first housing is open relative to said second housing; and
said second reception unit receives the radio-wave signal from the reception subantenna selected by said antenna selector.

6. The portable radio apparatus of claim 1, wherein:
said plurality of radio antennas comprise one or more main transmission/reception antennas and two or more reception subantennas;
said main transmission/reception antennas are used for both signal transmission and radio wave reception;
said reception subantennas are used only for radio wave reception, not used for signal transmission; and
one or more of said two or more reception subantennas are disposed in a direction different in polarization plane from said one or more main transmission/reception antennas.

7. The portable radio apparatus of claim 6, further comprising:
a coupler that adds two or more radio-wave signals outputted from said plurality of reception subantennas and inputs a resultant addition signal to any one of said two or more reception units.

8. The portable radio apparatus of claim 7, further comprising:
a phase adjuster that adjusts phases of said two or more radio-wave signals outputted from said two or more reception subantennas so as to be in-phase with each other; and wherein:
said coupler receives said two or more radio-wave signals whose phases are adjusted by said phase adjuster.
